(19) United States
(12) Patent Application Publication
(10) Pub. No.: US 2005/0175775 A1
(43) Pub. Date: Aug. 11, 2005

(54) Device and method for forming improved resist layer

(76) Inventor: Paul D. Shirley, Meridian, ID (US)

Correspondence Address: DINSMORE & SHOHL LLP;Suite 500, One Dayton Centre, Dayton, OH, 45402-2023, US

(21) Appl. No.: 10/773,968

(22) Filed: Feb. 6, 2004

(51) Int. Cl. B05D 3/12; B05C 5/02

(52) U.S. Cl. 427/240; 118/715; 118/722; 118/624

(57) ABSTRACT

A device and method for improving the uniformity of resist layers. The method includes controlling the evaporation of solvent from a deposited resist layer by impinging a control fluid onto a deposited resist layer. Optional sensing of flow parameters and other environmental conditions (such as temperature or humidity) adjacent the deposited resist layer, as well as determining whether a deviation exists between the sensed parameter(s) and a predetermined reference amount, and adjusting the appropriate parameter(s) to reduce the deviation if such deviation exists could also be performed. The device may also include a rotatable substrate support that can be used in conjunction with the control fluid supply.

### BACKGROUND OF THE INVENTION

The present invention relates generally to forming a uniform layer on a substrate, and more particularly to controlling environmental conditions during the formation of a resist layer to improve uniformity of the layer thickness.

Lithographic processes are extensively used in the manufacture of semiconductors and related electronic devices, where a layer of resist (also known as photoresist) is applied to a substrate to temporarily mask selected portions of the substrate, after which the resist is removed to permit subsequent substrate processing. Resist materials are generally composed of a mixture of organic resins, solvents and sensitizers. The resins make up the bulk of the finished resist, defining the body with various suitable mechanical properties. Solvents are added to lower the viscosity of the resist, thereby enabling a more uniform application of the resist onto the substrate. After the resist layer is formed, it is typically heated to evaporate the solvents and harden the layer. The sensitizers are configured to undergo a chemical change upon exposure to radiant energy, such as visible and ultraviolet light, thereby allowing the resist to cure into its final desired shape. The hardened resist layer is then selectively irradiated, where a reticle or related mask is used to define a predetermined circuit pattern.

One common method of applying the resist is by means of a spin coating process that typically takes place in a controllable environment, such as an enclosed (or at least partially enclosed) spin coat station. In such method, the resist in liquid form is deposited at the center of the substrate that is being spun around (such as a semiconductor wafer) to spread the resist outwardly by centrifugal force. In an ideal process, the thickness of the resulting resist layer is both uniform over the entire wafer and repeatable from wafer to wafer. Unfortunately, variations in environmental conditions, including (among others) airflow and humidity within the station, can be detrimental to the attainment of the aforementioned ideals, as the evaporation rate of solvents initially present in the resist exhibit considerable dependence on such environmental conditions. Because the solvent concentration is related to the resist viscosity and ultimately the thickness of the deposited resist layer, fluctuations in environmental conditions must be compensated for in order to improve uniformity in resist layer thickness.

### SUMMARY OF THE INVENTION

These needs are met by embodiments of the present invention where, according to a first aspect, a device for depositing resist on a substrate is disclosed. The device includes a rotatable substrate support with a first surface onto which a layer of resist may be deposited, a resist dispenser fluidly adjacent the first surface for depositing the resist layer onto the first surface, a control fluid supply configured to impart a control fluid onto a portion of the resist that has been deposited onto the first surface, and a controller configured to vary the placement of the control fluid onto the deposited layer of resist. In this way, the control fluid effects a local change in the evaporation rate of the deposited layer of resist, thereby facilitating the formation of a substantially uniform thickness of the deposited resist layer. In the present context, a local change in evaporation rate is distinguished from that produced over the substantial entirety of the resist layer in that discrete (rather than global) thickness changes can be effected. Optionally, the control fluid supply comprises a fluid dispensing nozzle that is moveable relative to the rotatable substrate support, while in the alternative, the control fluid supply includes a plurality of fluid dispensing nozzles. These nozzles are preferably fixed, but could also be made to be movable.

According to another aspect of the invention, a device for depositing a solution on a substrate is disclosed. The device includes a rotatable substrate support with a first surface upon which a layer of solution can be deposited, a solution dispenser fluidly adjacent the support first surface, a fluid supply, and a controller. In the present context, two or more components are “fluidly adjacent” with one another when fluid dispensed by one can be conveyed to the other, even if the components are not in physical contact with or connected to one another. As applies to the present invention, a solution dispenser is located relative to the substrate support such that at least a portion of the fluid being dispensed by the former can come in contact with the latter or, if the latter is covered by a substrate (such as a semiconductor wafer), the substrate that is placed on the support. The fluid supply is configured to impart a control fluid onto a portion of the solution that has been deposited onto the first surface. In this form, the control fluid emanating from the fluid supply effects a local change in evaporation rate of the deposited layer of solution on a predetermined substrate location. As discussed in the previous aspect, that the change is “localized” and brought about by having the control fluid only impact a “portion” of the solution implies that the use of the control fluid is meant to be discretely rather than indiscriminately placed. As such, a dispensing nozzle or related control fluid orifice needs to be capable of facilitating such localized interaction. The controller can be used coordinate the operation of one or more of the rotatable substrate support, solution dispenser and fluid supply to effect a local change in the evaporation rate of the deposited layer of resist and consequent formation of a substantially uniform thickness of the deposited resist layer, similar to that of the previous aspect. As such, the controller may vary one or more operational parameters, such as rotational speed of the substrate support, rate of deposition of the solution or location, or rate of deposition of the control fluid. The controller may include at least one detector configured to sense a fluid flow parameter corresponding to the fluid supply, as well as a feedback apparatus responsive to the detector such that if a deviation between the sensed parameter and a predetermined reference exists, the controller adjusts the supply to reduce the deviation. The controller may also be responsive to operator input, or can have such input (or other predetermined conditions) stored in the controller's memory such that it can be accessed by the controller on an as-needed basis.

Optionally, the support is a wafer chuck that can hold a semiconductor wafer. In addition to the fluid supply, the device may also include a humidity supply and a temperature supply, the former to humidify a region that includes at least the first surface and any solution deposited thereon, the latter in the exemplary form of a heater or cooler to adjust the temperature either adjacent the wafer chuck or the solution being deposited. In a preferred form, the control fluid supply is an air source, although it will be appreciated that other fluid forms (such as nitrogen, argon or other substantially inert gases) are also suitable. Moreover, the airflow from the air source can be directed to impinge on the substrate in a substantially downward direction. A dispensing nozzle coupled to the fluid supply can be made vertically and horizontally moveable relative to the first surface; this permits the localized application of the control fluid onto different locations of the deposited solution, depending on need. The dispensing nozzle and controller can be arranged to be cooperative with one another such that the dispensing nozzle can move in response to a sensed deviation or other control signal as dictated by either the controller or a user input. The controller, while preferably automated, may also operate in a semi-automated mode or a manual mode, thereby permitting the controller to be additionally responsive to, for example, an operator input. In addition to the aforementioned control fluid flow detector, any or all of temperature, humidity and thickness detectors may be included, where the last can measure the thickness of the solution that has been deposited onto the substrate. In addition, one or more of such detectors may be coupled to the controller to provide additional means of controlling either the deposition of solution on the substrate or the flow of control fluid coming from the fluid supply.

According to another aspect of the invention, a device for depositing a solution on a substrate is disclosed. The device includes a rotatable wafer chuck, a solution dispenser fluidly adjacent a first surface on the wafer chuck, a housing disposed about the wafer chuck such that a substantially controllable environment is formed within the housing, a fluid supply in fluid communication with the substantially controllable environment, and a controller substantially similar to that described in the previous aspect. In the present context, the term “substantially” refers to an arrangement of elements or features that, while in theory would be expected to exhibit exact correspondence or behavior, may, in practice embody something less than exact. As such, the term denotes the degree by which a quantitative value, measurement or other related representation may vary from a stated reference without resulting in a change in the basic function of the subject matter at issue. As applied to the present housing, it implies that while the housing may be closed such that an environment formed inside the housing is virtually isolated from the ambient environment outside the housing, such virtual isolation is not necessary, as long as the controller and the one or more sources of environmental change (fluid flow, humidity or temperature) are capable of maintaining the environment inside the housing in a manner sufficient to achieve the desired thickness of the as-deposited solution. Optionally, the device further includes at least one exhaust or drain to remove excess resist, ambient environment or the like from the substantially controllable environment. p According to another aspect of the invention, a resist application device is disclosed. The device includes a rotatable wafer chuck, a dispenser configured to deposit a resist onto a substrate placed on the wafer chuck, a housing disposed about the wafer chuck such that a substantially controllable environment is formed within the housing, a control fluid supply fluidly coupled to the substantially controllable environment, and a controller configured to vary the placement of the control fluid onto the deposited layer of resist. The control fluid coming out of the fluid supply can be air or another gas, and can have its flow rate or position relative to the deposited resist layer varied (through, for example, changes in valve settings, control fluid pressure sources or nozzle positioning). Optionally, one or more control fluid detectors can be included to sense a control fluid flow parameter in the substantially controllable environment, where additionally the controller is responsive to the detectors such that upon a deviation between the sensed parameter (or parameters) and a corresponding predetermined reference level, the controller adjusts the control fluid source to reduce the deviation.

According to yet another aspect of the invention, a resist application device is disclosed. The device includes a rotatable wafer chuck, dispenser, controller and housing as previously described, and an airflow supply fluidly coupled to the resist that has been deposited onto a generally upper surface of the wafer chuck such that upon impingement of the airflow onto an desired part of the resist, the airflow produces a localized change in evaporation rate of the deposited resist relative to portions of the resist that are not substantially exposed to the impingement. In the present context, “impingement” includes that airflow that is directed onto a discrete location on the target surface (in this case, the deposited resist layer) from the airflow supply such that the impinging air does not significantly interact with the ambient air or related environment until after it has interacted with the target surface. This further implies more than mere contact between the air and an adjacent surface to which the air is directed; it necessitates that the air flowing from the supply travels a substantially direct path to the target surface. This flowing air achieves the desired local change in evaporation rate substantially independent of contributions from generally static ambient air, recirculating air and mixed air that forms as a result of the impinging air, as well as on air on an opposing side of the target that is not in the impinging fluid's direct path. Optionally, the device further includes an airflow detector configured to sense an airflow level (such as the aforementioned airflow rate) in the substantially controllable environment, where the controller is responsive to the detector such that upon a deviation between the sensed airflow level and a predetermined reference level, the controller can adjust the airflow supply to substantially reduce the deviation.

According to still another aspect of the invention, a method of controlling the evaporation of solvent from a deposited resist layer is disclosed. The method includes depositing resist onto a rotating substrate and impinging a control fluid onto a portion of the deposited resist to effect a local thickness change through modification of the evaporation rate of the solvent in the resist. The amount of control fluid that can be impinged on the deposited resist can be increased or decreased accordingly. Optionally, the method includes sensing a parameter corresponding to a fluid flow rate adjacent the substrate, determining whether a deviation exists between the sensed parameter and a predetermined reference amount, and if such deviation exists, adjusting the parameter to reduce the deviation. In addition to sensing the fluid flow rate, humidity can also be sensed and controlled by including the appropriate supply and sensors, as previously discussed. In one embodiment, the fluid flow is airflow. In addition, a housing can be placed around the substrate to form a substantially controllable environment. In addition to controlling fluid flow rate, humidity or both, the method can also include controlling the temperature within the substantially controllable environment.

According to another aspect of the invention, a method of depositing a resist onto a substrate is disclosed. The method includes configuring a device to comprise a rotatable substrate support, resist dispenser, fluid supply and controller as previously discussed in one or more of the previous aspects. Once the device is properly configured, a substrate is placed on the support, after which both are rotated such that resist flows from the dispenser onto the substrate. After that, the control fluid is impinged onto a portion of the resist layer to effect the local change in evaporation rate of the solvent. As previously discussed, the substrate is preferably a semiconductor wafer, while the supply comprises an airflow supply. Optionally, one or more detectors are included to sense a fluid flow parameter to determine whether a deviation exists between the sensed parameter and the predetermined reference. If a deviation exists, the controller operates to reduce the deviation. In addition to using airflow to control resist layer thickness, humidity and temperature supplies could be used, as mentioned previously. In these latter embodiments, the sensing and determining steps can be performed on more than one of the parameters.

In yet another aspect of the invention, a method of forming a resist layer is disclosed. The method includes configuring a device in a manner similar to that of the previous aspect, as well as placing the substrate on the support, rotating the support and substrate, depositing resist from the dispenser onto the substrate, sensing the fluid flow parameter, determining whether a deviation exists between the sensed parameter and the predetermined reference, and if the deviation exists, adjusting the supply to reduce the deviation, and then curing at least a portion of the resist. Optionally, the resist is formed by subjecting the resist to a first heat treatment, forming a pattern over the resist such that a portion of the resist is exposed to the source of radiation, removing either the exposed or non-exposed resist portions, and subjecting the portion of the remaining resist portion to a second heat treatment. In addition, the removing step can include removing the resist portion that was not exposed to the source of radiation during the exposing.

### BRIEF DESCRIPTION OF THE DRAWINGS

FIG. 1 is a sectional view of an undulated deposited resist layer on top of a wafer of the prior art where the resist layer is thicker at the outer periphery of the wafer;

FIG. 2 is a sectional view of an undulated deposited resist layer on top of a wafer of the prior art where the resist layer is thicker at the wafer center;

FIG. 3 is a sectional view of an undulated deposited resist layer on top of a wafer of the prior art where the resist layer is thicker at the wafer center and at the outer periphery of the wafer;

FIG. 4 is a sectional view of an undulated deposited resist layer on top of a wafer of the prior art where the resist layer is thicker at an intermediate position between the wafer center and the wafer outer periphery;

FIG. 5 is a schematic view of a resist application device according to an aspect of the present invention configured to avoid surface undulations in a deposited resist layer; and

FIG. 6 is a partial view of the device of FIG. 5, showing that a dispensing nozzle in the control fluid supply can be translated along a radial dimension of the wafer.

### DETAILED DESCRIPTION OF THE PREFERRED EMBODIMENTS

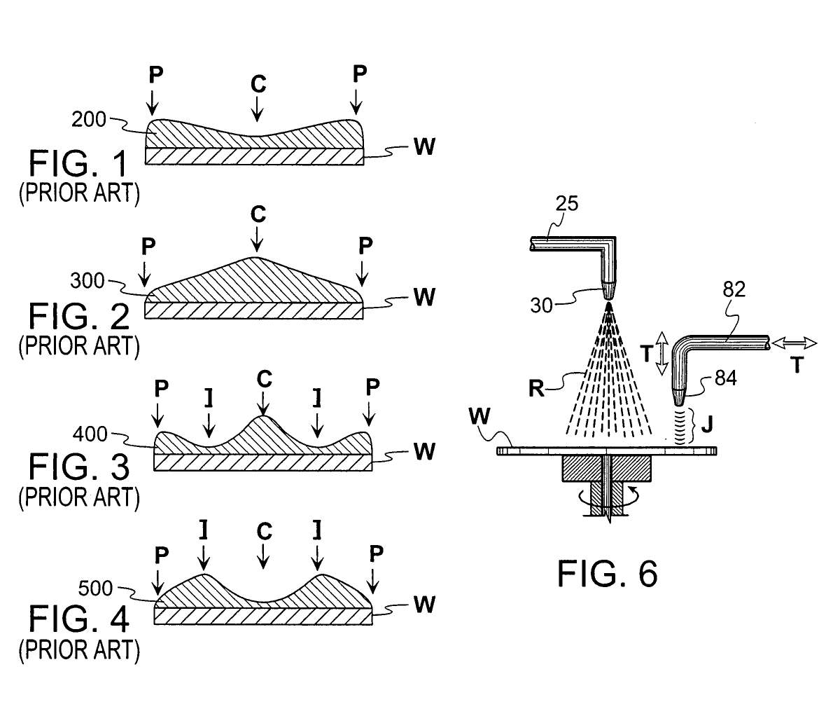

Referring first to FIGS. 1 through 4, environmental conditions around the spinning wafer W impact the viscosity of the resist and its consequent thickness once it is deposited on the wafer. For semiconductor applications, a resist layer thickness is typically between approximately 0.1 and 1 micron. The relative dimensions of the wafer W and the resist laye2 100, 300, 400 and 500 disposed thereon shown in the figures are not to scale, but meant to show general trends in non-uniform resist layers in their as-deposited state. Solvents are initially a part of the resist solution, and are included to promote solution flowability and related deposition properties. Upon deposition and exposure to the ambient environment (such as air) A around the wafer W, the solvents evaporate. By controlling the rate of evaporation of solvent from the resist R as it is being deposited, embodiments of the present invention promote improvements in resist layer thickness uniformity relative to that shown in FIGS. 1 through 4. Because viscosity is generally inversely proportional to the amount of solvent in the resist, the evaporation process (which has a strong influence over how much solvent remains in the resist), if extremely high, can inhibit the tendency of the resist to level out during subsequent layer deposition. This leads to surface undulations such as shown in FIGS. 1 through 4 where, depending on the processing and environmental conditions, differing thicknesses are produced at the resist layer center C from the periphery P and the intermediate I. For example, extremely high viscosities have a tendency to yield the dome-like pattern shown in FIG. 2, while extremely low viscosities have a tendency to yield the bowl-like shape of FIG. 1.

Other variables can be used to adjust the thickness on different parts of the wafer. For example, a higher pre-chill temperature of the wafer W tends to increase the resist thickness around the outer perimeter, typically within approximately one inch of the wafer W periphery on an eight inch diameter wafer. Test results indicate that a 1° C. temperature rise in the wafer W will raise the outermost part of the wafer W by ten to twenty Angstroms. Similarly, the higher the resist temperature, the higher the center (typically the innermost one to two inches on an eight inch wafer W) of the deposited resist becomes. Test results indicate that a 1° C. temperature increase will increase the thickness of the center by about ten Angstroms. Likewise, the higher the ambient environment A temperature, the higher the evaporation rate. The impact of higher air (or related environment) temperatures have the same general effect as the aforementioned pre-chill temperature. Regarding humidity, the higher it is, the lower the resist thickness. Test results indicate that a 1% change in relative humidity will change resist layer thickness by approximately twenty Angstroms. Another parameter, varying the “spin out” time of the wafer W, will yield different resist profiles, as shown in FIGS. 3 and 4, where the viscosity of the resist in combination with the spin speed of wafer W on the chuck can be parametrically combined to achieve a certain thickness in the resist layer at the center C, intermediate I or periphery P. Exhaust rates also have an impact on the outer periphery (such as the outer one inch) of wafer W, where the higher the exhaust, the higher the air flow, and the thicker the resist.

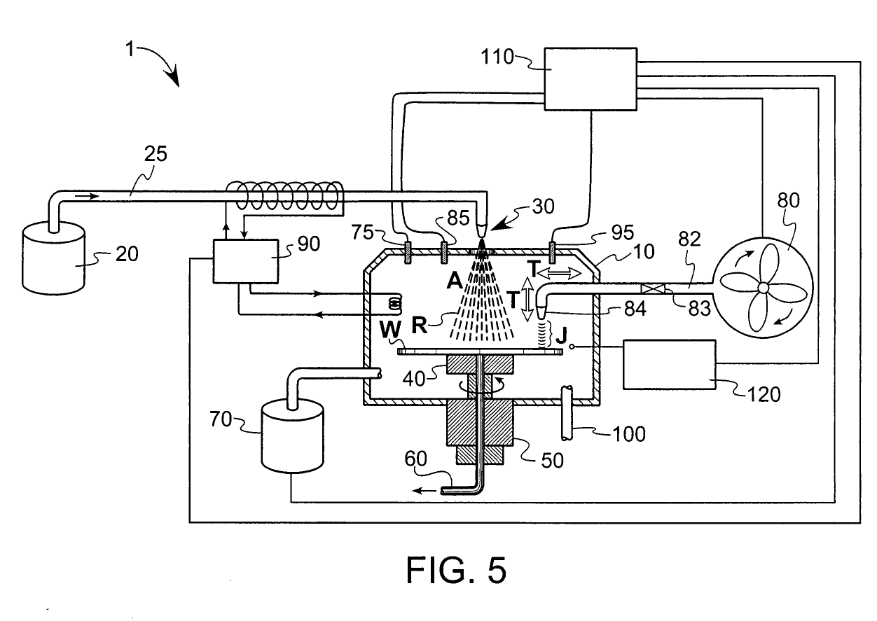

Referring next to FIG. 5, a resist application device 1 includes a housing 10 and resist supply 20 that terminates at dispensing nozzle 30 to dispense resist R. A support (in the form of a wafer chuck) 40 defines a generally planar a disc-like upper surface upon which a workpiece (such as a semiconductor wafer W) can be placed. Support 40 can be rotated about a generally vertical axis by motor 50. A vacuum 60 applied through the support 40 can be used to secure wafer W to support 40. It will be appreciated that the rotational speed of motor 50 can be adjusted to account for (by way of example) changes in resist viscosity during deposition or large wafers. For example, wafer chuck 40 can be rotated at a low starting speed (for example, 1000 rotations per second) and then rotated at a higher speed (for example, between 4000 and 6000 rotations per second) later on in the deposition process.

Housing 10 can at least partially enclose the support 40 to provide a substantially controllable environment inside. Environmental control inside housing 10 can be effected by a humidity supply 70, control fluid supply 80 and temperature supply 90, each of which is accompanied by at least one respective detector 75, 85 and 95 for measuring the corresponding environmental parameters. It will be appreciated that although the figures notionally show one of each type of detector, there can be numerous detectors of each type situated in various locations within housing 10. Examples of parameters that can be sensed include (but are not limited to) flow rates, temperature and humidity. In addition, drain/exhaust lines 100 pass through housing 10 to permit excess resist, airflow or the like to exit housing 10. Controller 110 coordinates the environmental activity within housing 10, and includes feedback circuitry to compare parameters sensed by detectors 75, 85 and 95 to a predetermined value and, if necessary, send a control signal to one or more of the respective humidity supply 70, control fluid supply 80 or temperature supply 90 to adjust the corresponding parameter. A layer thickness monitor 120 may be included to provide indicia of resist thickness as it is being deposited onto wafer W. As with the other sensed parameters, the information being sensed by the layer thickness monitor 120 can be fed back to controller 110 to permit manipulation of one or more of the humidity, airflow or temperature supplies. It will further be appreciated that the present invention need not even require the use of detectors 75, 85 and 95 during the resist layer deposition process, as data previously collected (during system setup, for example) could be used to dictate placement of nozzle 84, and what flow rate should be used. In this configuration, the relatively stable, robust nature of the setup and deposition process could be used to simplify the system by not requiring the real-time monitoring afforded by detectors 75, 85 and 95.

As previously mentioned, the thickness of the applied resist R is dependent upon (among other things) its viscosity, which is in turn dependent upon the amount of solvent in the resist R. The rate of solvent evaporation from the resist is dependent upon various environmental conditions (such as the airflow, humidity and temperature) within the ambient environment, and with housing 10 providing at least a partially controlled environment, the control fluid supply 80, humidity supply 70 and temperature supply 90, along with accompanying controller 110 can be used singly or in conjunction with one another to tailor the solvent evaporation rate in order to facilitate a desired resist thickness. Of the aforementioned environmental conditions, the inventor has determined that the introduction of local airflow J at discrete locations on the newly-deposited layer of resist R exerts a particularly strong influence on solvent evaporation and consequent resist layer thickness. This discrete, localized introduction of air (or other gases) can be used to offset the effects of inherent ambient atmospheric properties adjacent the deposited resist layer, where the rotating interface between the wafer W being coated and the ambient air A adjacent the wafer W that is inherent in spin coating devices produces relative airspeed differences between the outer periphery and the wafer center. Without the introduction of localized airflow according to the present invention to overcome them, these differences can contribute to uneven convective heat transfer and concomitant surface temperature variations and resist layer thickness. In addition, the higher airspeed at the periphery of a spinning wafer with resist deposited on it produces an increase in the thickness of the film due to the enhanced off-gassing of solvent and subsequent drying effect. Furthermore, the movement of ambient air A is used to carry away evaporated solvent, mist and particulate formation, the latter due to, among other things, the build-up and subsequent flaking off of resist that has spun off the wafer W and onto the wall of housing 10.

Control fluid flow from the control fluid supply 80 is provided to discrete locations on the surface of resist R deposited on wafer W, and can be used to vary the rate of evaporation of the deposited resist R. In one preferred form, air is the control fluid, although it will be appreciated that other control fluids can be used besides air. For example, substantially inert gases (such as argon, nitrogen or the like) could be used in situations where contaminants in the air, or the air's inherent reactivity due to its substantial oxygen presence, may preclude its use. A fan (as shown) or other airflow-inducing device (such as a compressor) can be used to generate a flow of air that is then routed through conduit 82 and discharged from nozzle 84. Valve 83 can be used to cut off airflow in response to an appropriate signal from controller 110. The control fluid J exits nozzle 84 in a more collimated, jet-like pattern than that of the relatively diffuse pattern of resist R exiting dispensing nozzle 30. Since the diameter of the area on wafer W that needs to be affected will generally be anywhere from approximately one half to two inches, an appropriate nozzle area should be no larger than approximately one half inch. By moving the nozzle 84 closer to or farther away from the surface (as shown by either or both horizontal and vertical translation T) defined by the deposited resist, corresponding larger or smaller portions of the resist layer can be bathed in the impinging control fluid. As an alternative (not shown), multiple nozzles 84 can be employed to increase or tailor area coverage. By maintaining the flow of control fluid J in a substantially coherent form, the efficacy of control fluid J is enhanced, as the flow of air or related fluid can more easily modify ambient atmosphere temperature, humidity or circulation conditions, and its placement on the uncured layer of resist R can be more precisely controlled. The use of a moving flow of control fluid J through movable nozzle 84 can be so effective that it could either augment or replace other environmental control devices, such as the aforementioned temperature and humidity supplies 90 and 70, respectively. Moreover, the airflow introduced can be used to cool select portions of the backside of wafer W to promote a more favorable temperature distribution.

Referring next to FIG. 6 in conjunction with FIG. 5, the ability of the nozzle 84 and a portion of conduit 82 of control fluid supply 80 to vary the placement of the control fluid J is shown. Since control fluid J is discharged from and deposited onto deposited layer of resist R in a relatively collimated flow, it impinges on the layer in discrete locations. By translating T the nozzle 84 relative to the spinning wafer W and layer of resist R disposed thereon, the device can compensate for otherwise unsatisfactory localized environmental conditions. For example, if it is required to reduce the thickness peaks at intermediates I of the layer 500 of FIG. 4, the nozzle 84 can be moved in proximity to the intermediates I to impart flow of control fluid J thereon. As previously discussed, nozzle 84 translation T can be in both horizontal and vertical directions as needed, and nozzle 84 can have its movement governed either automatically through controller 110 or by manual operation. An alternative approach (not shown) is to use a plurality of dispensing nozzles similar to nozzle 84 that can be arranged in an array or related configuration to achieve the same localized deposition as with the translating nozzle 84. In such a configuration, individual control valves (similar to valve 83) could be governed by controller 110 in response to sensed conditions within ambient air A to actuate a respective nozzle.

In another approach, the control fluid supply 80 and its ancillary components could be coupled with variations in the rotational speed of wafer chuck 40. Inclusion of controller 110 to coordinate control fluid flow and resist spin speed offers additional parametric control over the deposition and subsequent layer thickness formation of the resist on wafer W. In one form, detectors or sensors similar to those used to sense airflow, humidity and temperature parameters could be used as part of a feedback mechanism for real-time control, while in another, the motor 50 and control fluid supply 80 (including movement of nozzle 84 along one or both translational paths T) can be coordinated to produce a resist layer of the desired thickness.

Environmental humidity and temperature are additional conditions affecting the resist layer thickness. As a general rule, layer thickness increases with decreasing humidity, due to more rapid solvent evaporation. In the present system, controller 110 can also sense humidity or temperature changes during layer deposition, and can change one or more operational parameters to compensate. For example, gases (including solvent-containing gases) can be added to or removed from ambient air A to maintain a preferred humidity. The present system can be used to achieve humidity and temperature changes both locally (through the use of the aforementioned control fluid supply 80), as well as in the substantial entirety of the ambient atmosphere either within housing 10 or otherwise surrounding the deposited layer of resist R (through the use of the humidity supply 70 or temperature supply 90).

While the embodiments and systems discussed herein have been directed to a particular fill pattern, it is within the scope of the present invention to include similar simplistic, repeating arrangements to achieve the same end. Thus, having described the present invention in detail and by reference to the embodiments thereof, it will be apparent that modifications and variations are possible without departing from the scope of the invention in the following claims.

1. A device for depositing resist onto a substrate, said device comprising:
a rotatable substrate support comprising a first surface onto which a layer of resist may be deposited;
a resist dispenser fluidly adjacent said first surface for depositing said layer on said first surface;
a control fluid supply configured to impart a control fluid onto a portion of said resist that has been deposited onto said first surface such that said control fluid emanating from said supply effects a local change in evaporation rate of said deposited layer of resist; and
a controller configured to vary the placement of said control fluid onto said deposited layer of resist to effect a substantially uniform thickness layer thereof.

2. A device according to claim 1, wherein said control fluid supply comprises a fluid dispensing nozzle that is moveable relative to said rotatable substrate support.

3. A device according to claim 1, wherein said control fluid supply comprises a plurality of fluid dispensing nozzles.

4. A device according to claim 3, wherein said plurality of fluid dispensing nozzles occupy a substantially fixed location relative to said rotatable substrate support.

5. A device for depositing a solution on a substrate, said device comprising:
a rotatable substrate support comprising a first surface onto which a layer of solution may be deposited;
a solution dispenser fluidly adjacent said first surface for depositing said layer on said first surface;
a fluid supply configured to impart a control fluid onto a portion of said solution that has been deposited onto said first surface such that said control fluid emanating from said fluid supply effects a local change in evaporation rate of said deposited layer of solution; and
a controller comprising:
at least one detector configured to sense a parameter corresponding to said control fluid; and
a feedback apparatus responsive to said detector such that upon a deviation between said sensed parameter and a predetermined reference, said controller adjusts said fluid supply to reduce said deviation.

6. The device of claim 5, wherein said support is a wafer chuck.

7. The device of claim 6, wherein said fluid supply comprises an airflow supply.

8. The device of claim 6, further comprising a humidity supply configured to humidify airspace adjacent said wafer chuck.

9. The device of claim 6, further comprising a temperature supply configured to adjust temperature adjacent said wafer chuck.

10. The device of claim 9, wherein said air supply is configured to impart airflow onto a predetermined substrate location in a substantially vertically downward direction.

11. The device of claim 5, wherein said controller is configured to operate in a plurality of modes comprising a substantially automated mode and a manual mode, the second of which permits said controller to be additionally responsive to an operator input.

12. The device of claim 5, wherein a dispensing nozzle coupled to said fluid supply is moveable relative to said first surface such that said control fluid can be imparted onto different said portions of said deposited solution.

13. The device of claim 12, wherein said dispensing nozzle and said controller are cooperative such that said dispensing nozzle moves in response to said deviation.

14. A device for depositing a solution on a substrate, said device comprising:
a rotatable wafer chuck comprising a first surface onto which a layer of solution may be deposited;
a solution dispenser fluidly adjacent said first surface for depositing said layer on said first surface;
a housing disposed about said wafer chuck such that a substantially controllable environment is formed within said housing;
a fluid supply in fluid communication with said substantially controllable environment, said fluid supply configured to impart a control fluid onto a portion of said solution that has been deposited onto said first surface such that said control fluid emanating from said fluid supply effects a local change in evaporation rate of said deposited layer of solution; and
a controller comprising:
at least one detector configured to sense a parameter corresponding to said control fluid; and
a feedback apparatus responsive to said detector such that upon a deviation between said sensed parameter and a predetermined reference, said controller adjusts said fluid supply to reduce said deviation.

15. The device of claim 14, further comprising at least one of an exhaust or drain in said substantially controllable environment.

16. A resist application device comprising:
a rotatable wafer chuck comprising a first surface onto which a layer of resist may be deposited;
a dispenser configured to deposit said layer onto said first surface;
a housing disposed about said wafer chuck such that a substantially controllable environment is formed within said housing;
a fluid supply fluidly coupled to said substantially controllable environment, said fluid supply configured to impart a control fluid onto a portion of said layer that has been deposited onto said first surface such that said control fluid emanating from said fluid supply effects a local change in evaporation rate of said layer; and
a controller configured to vary the placement of said control fluid onto said deposited layer of resist to effect a substantially uniform thickness layer thereof.

17. The device of claim 16, further comprising a detector configured to sense a parameter associated with said control fluid in said substantially controllable environment such that said controller is responsive to said detector such that upon a deviation between said sensed parameter and a corresponding predetermined reference level, said controller adjusts said supply to reduce said deviation.

18. The device of claim 16, wherein said control fluid comprises air.

19. The device of claim 16, wherein said control fluid is a substantially inert gas.

20. A resist application device comprising:
a rotatable wafer chuck;
a dispenser configured to deposit said resist onto a generally upper surface of said wafer chuck;
a housing disposed about said wafer chuck such that a substantially controllable environment is formed within said housing;
an airflow supply fluidly coupled to said resist deposited on said generally upper surface such that upon impingement of said airflow onto a desired part of said resist, said airflow produces a localized change in evaporation rate of said deposited resist relative to parts of said resist that are not substantially exposed to said impingement; and
a controller configured to vary the placement of said airflow onto said deposited layer of resist to effect a substantially uniform thickness layer thereof.

21. A method of controlling the evaporation of solvent from a deposited resist layer, said method comprising:
depositing resist onto a rotating substrate; and
impinging a control fluid onto a portion of said deposited resist prior to curing of said resist such that said control fluid effects a local change in evaporation rate of said deposited resist.

22. The method of claim 21, further comprising:
sensing an evaporation parameter corresponding to said control fluid;
determining whether a deviation exists between said sensed parameter and a predetermined reference amount; and
if said deviation exists, adjusting said parameter to reduce said deviation.

23. The method of claim 22, wherein said sensed parameter is a flow rate of said control fluid.

24. The method of claim 21, wherein said control fluid comprises air.

25. The method of claim 21, including placing a housing around said substrate to form a substantially controllable environment.

26. The method of claim 25, including controlling temperature within said substantially controllable environment.

27. The method of claim 25, including controlling humidity within said substantially controllable environment.

28. The method of claim 22, wherein said adjusting comprises selectively increasing or decreasing said control fluid impingement.

29. The method of claim 28, wherein said selective increasing or decreasing comprises moving a dispensing nozzle of said supply of control fluid relative to said substrate.

30. A method of depositing a resist onto a substrate, said method comprising:
configuring a device to comprise:
a rotatable substrate support comprising a first surface onto which a layer of said resist may be deposited;
a resist dispenser;
a fluid supply configured to impart a control fluid onto a portion of said resist layer such that said control fluid emanating from said fluid supply effects a local change in evaporation rate of said resist layer; and
a controller configured to vary the placement of said control fluid onto said deposited layer of resist to effect a substantially uniform thickness layer thereof;
placing said substrate on said support;
rotating said substrate;
depositing resist from said dispenser onto said substrate to form said resist layer thereon; and
impinging said control fluid onto a portion of said resist layer to effect said local change in said evaporation rate therefrom.

31. The method of claim 30, further comprising:
providing at least one detector configured to sense a parameter corresponding to said fluid supply;
sensing said fluid flow parameter with said detector;
comparing said sensed parameter to a predetermined reference to determining whether a deviation exists between said sensed parameter and said predetermined reference; and
if said deviation exists, adjusting said fluid supply to reduce said deviation.

32. The method of claim 31, further comprising providing a feedback apparatus responsive to said detector such that said feedback apparatus performs said adjusting said fluid supply.

33. The method of claim 31, wherein said substrate is a semiconductor wafer.

34. The method of claim 31, wherein said control fluid comprises air.

35. A method of forming a resist layer, said method comprising:
configuring a device to comprise:
a rotatable substrate support;
a resist dispenser;
a fluid supply fluidly adjacent said support, said fluid supply configured to impart a control fluid onto a portion of said resist layer such that said control fluid emanating from said fluid supply effects a local change in evaporation rate of said resist layer; and
a controller comprising:
at least one detector configured to sense a fluid flow parameter corresponding to said fluid supply; and
a feedback apparatus responsive to said detector such that upon a deviation between said sensed parameter and a predetermined reference, said controller adjusts said fluid supply to reduce said deviation;
placing said substrate on said support;
rotating said support and substrate;
depositing resist from said dispenser onto said substrate;
sensing said control fluid parameter;
determining whether a deviation exists between said sensed parameter and said predetermined reference;
if said deviation exists, adjusting said supply to reduce said deviation; and
curing at least a portion of said resist.

36. The method of claim 35, wherein said resist is cured by:
subjecting said resist to a first heat treatment;
forming a pattern over said resist to define, upon exposure of said pattern to a source of radiation, a first resist portion and a second resist portion;
exposing said pattern and at least one of said resist portions to said source of radiation;
removing one of said first or second resist portions; and
subjecting the portion of the remaining resist portion to a second heat treatment.

37. The method of claim 36, wherein said removing comprises removing the resist portion that was not exposed to said source of radiation during said exposing.
